(19) United States
(12) Patent Application Publication
(10) Pub. No.: US 2022/0015411 A1
(43) Pub. Date: Jan. 20, 2022

(54) CIGARETTE-MAKING MACHINE AND METHOD FOR PRODUCING CIGARETTES

(71) Applicant: Roger Koch, Rorschach (CH)

(72) Inventor: Roger Koch, Rorschach (CH)

(21) Appl. No.: 17/299,754

(22) PCT Filed: Dec. 2, 2019
(86) PCT No.: PCT/CH2019/050027

§ 371 Date: Jun. 3, 2021

(30) Foreign Application Priority Data
Dec. 3, 2018 (CH) 01485/18

(51) Int. Cl. A24C 5/18; A24C 5/39; A24D 1/18; A24C 5/32

(52) U.S. Cl. CPC A24C 5/1892; A24C 5/392; A24C 5/394; A24C 5/1807; A24C 5/32; A24C 5/399; A24D 1/18; A24C 5/393; A24C 5/396

(57) ABSTRACT

A method of producing cigarettes in a cigarette machine provides that separated tobacco is sucked to a lower side of an air-permeable conveyor belt. A suction bar is above the conveyor belt, which is connected to an air suction, the tobacco being formed into a tobacco rod at the lower side of the first conveyor belt, by being compressed at the lower side of the conveyor belt by the suction flow. The tobacco rod is transferred from the conveyor belt to a second conveyor belt, on which upper side a cigarette paper band is arranged. The cigarette paper band is glued along the longitudinal direction of the rod and the tobacco rod is cut into cigarettes. A smokable additive substance is metered into the suction stream mixed with tobacco and the tobacco rod is formed from the tobacco and the additive substance at the lower side of the first conveyor belt.

### CROSS-REFERENCE TO RELATED APPLICATIONS

This application is a national phase entry under 37 U.S.C. § 371 of PCT/CH2019/050027 filed Dec. 2, 2019, which claims priority to Swiss Patent Application No. 01485/18 filed Dec. 3, 2018, the entirety of each of which is incorporated by this reference.

### FIELD OF THE INVENTION

The invention relates to a method for the production of cigarettes and to a cigarette machine for implementing the method.

### PRIOR ART

From the prior art, cigarette rod machines have been known for more than 100 years. A cigarette rolling machine consists of a distributor unit in which vibrating shaft walls and/or a roller with steel pins ensure uniform distribution of the cut tobacco arriving by a conveyor belt within the distributor box. At the bottom of the box, the mixed tobacco is finely and evenly pulled apart. This is done by means of an air-permeable textile conveyor belt (the so-called suction rod conveyor), which moves the tobacco evenly from the distributor box. To ensure that the tobacco remains on the belt, a vacuum acts underneath the air-permeable conveyor belt so that the tobacco is sucked onto the belt and thus virtually fixed. At the end of the suction rod conveyor is an excess removal device consisting of two rotating trimming discs which remove excess tobacco fibers from the tobacco rod. Depending on the position of the trimmer discs relative to the conveyor belt, a greater or lesser amount of tobacco is removed. The excess tobacco falls into a chute and is returned to the distributor unit.

The tobacco rod is then deposited by the suction rod conveyor onto a continuously running format belt, which forms the tobacco rod into a round shape. The tobacco rod then passes through a narrowed mouthpiece, where the cigarette paper is wrapped around the tobacco rod from the outside. This station is also called the format chamber. At this point, there is also a glue nozzle with food-grade glue, which continuously glues the cigarette paper to one edge. A short heating section then ensures that the glue can set. In addition, the glue seam is smoothed in the process. The result is an endless, wrapped and glued tobacco rod.

In an alternative manufacturing method for producing a cigarette, the cut tobacco is separated in a feeder. The separated tobacco falls onto a conveyor belt at the lower end of the tobacco sifter. The excess tobacco dust is removed, e.g., sucked off, in an excess removal device. The tobacco is formed into a rod on the conveyor belt by a metering wheel. The tobacco rod is compressed by at least one press wheel. Then the tobacco rod is fed through a narrowed mouthpiece and the tobacco rod is wrapped with cigarette paper at the mouthpiece. The cigarette paper is glued along the longitudinal direction of the rod.

If cigarettes are to be manufactured that contain another smokable substance instead of or in addition to tobacco, problems may arise with the processing of this additional substance.

DE 10 2006 027 597 A1 describes a mode of operation of a rod machine in the tobacco processing industry. Tobacco is sucked by means of suction air through a suction shaft to a suction belt. A nozzle is arranged on the channel wall of the suction shaft, via which a fluid is metered into the tobacco.

DE 10 2004 017 618 A1 describes a method for producing a smokable article. An extrudate rod is fed to a suction rod conveyor alongside the tobacco. The extrudate is formed from a base component and a discontinuously metered additive. As a result, there is no additive on the front end of the smokable article where the article is ignited.

DE 38 21 677 A1 describes a method for producing flavored rod-shaped smoking material. To ensure that the liquid carrying the flavoring substance, for example menthol, does not form stains on the cigarette paper, the liquid is added between a first and second half of the tobacco rod.

EP 2 883 462 A1 describes a method for feeding a rod machine with a product stream of fiber material enriched by additives. The fiber material consists of tobacco fibers and/or filter material fibers. By feeding the product stream directly into the sifter channel, the fiber material is uniformly distributed in the product stream.

EP 3 020 288 A1 also discloses a method for forming a tobacco rod. The short tobacco that is inevitably extracted with the suction air is freed from fine dust in a separator and is returned to the tobacco fibers.

### ADVANTAGES OF THE INVENTION

The present invention provides a method for the production of cigarettes which makes it possible to produce cigarettes containing a smokable additive substance in addition to the tobacco without the additive substance impairing the production method, in particular the production speed, or without there being an uneven distribution of the additive substance in the cigarettes.

### SUMMARY OF THE INVENTION

The solution of the present invention succeeds in a method for the production of cigarettes by the features indicated in the independent claims. Further developments and/or advantageous embodiments are the subject of the dependent patent claims.

The method provides that a smokable additive substance, which contains resins that contaminate the cigarette machine, is metered into the suction stream mixed with tobacco, and the tobacco rod, consisting of tobacco and the additive substance, is formed on the lower side of the first conveyor belt. The cigarette machine can process additives that would normally contaminate the cigarette machine to such an extent that they are difficult or impossible to process by feeding the additive into the suction flow, thereby ensuring that as few machine parts as possible come into contact with the additive. These include, for example, resinous plants the resin of which glues the parts of the cigarette machine with which the plants come into contact. It would be obvious to mix the additive with the tobacco before the mixture is fed to the cigarette machine in order to achieve a homogeneous mixture between the additive and the tobacco. In this case, however, a maximum number of parts of the cigarette machine come into contact with the additive and almost the entire cigarette machine is contaminated. In particular, the conveyor belt and the excess removal device become contaminated and can no longer perform their function satisfactorily.

Another advantage of the method is that any amount of additive can be added to the suction stream, so that the dosage does not represent a limiting factor for the production speed. Even if the production speed of the cigarettes corresponds to that which is usual for cigarettes without additive, a sufficient quantity of additive can be metered into the tobacco-added suction stream.

The invention provides that the smokable additive substance is added to the suction stream substantially in the middle of the width of the suction stream. Surprisingly, this location of addition of the additive substance results in a uniform distribution of the additive substance in the tobacco rod formed on the first conveyor belt. This fact contradicts the expectation that the additional substance accumulates at the bottom of the first conveyor belt and is therefore present inhomogeneously distributed in the tobacco rod.

In an embodiment of the invention, the smokable additive substance is metered into the suction flow by means of an oscillating conveyor device. This enables precise metering of the additional substance by setting the appropriate oscillation frequency. In addition, the oscillating conveyor device is robust and requires little maintenance.

In another embodiment of the invention, the vibratory conveying device comprises a spiral conveyor with a spiral-shaped spiral pot, which spiral pot is set in vibration, whereby the additional substance is conveyed in the direction of the suction flow. Typically, a spiral conveyor is used to separate individual parts and bring them into a specific position at the outlet of the spiral pot. This allows the individual parts to be held fast by a gripper. Surprisingly, it was found that the spiral conveyor conveys the additional substance as quickly and uniformly as desired. In this way, the spiral conveyor ensures that there is no bottleneck of added additive, even if the conveyor belt speed of the cigarette machine corresponds to the conveyor belt speed of a cigarette machine producing cigarettes without an added additive. The spiral conveyor also allows distribution rates of, for example, 20 percent by weight of additive to 80 percent by weight of cut tobacco.

It has proved useful if the spiral feeder is filled by a vibrating hopper as a function of the level of the additional substance in the spiral pot. In this way, the metering of the additional substance into the suction stream is fully automatic. If the vibratory hopper is empty, it can be refilled with additional substance at any time during operation.

In a further embodiment of the invention, the spiral feeder is filled by a vibrating hopper as a function of the filling level of the additional substance in the spiral pot. As a result, the spiral pot is always optimally filled so that a sufficient quantity of additional substance can be metered into the suction stream with great accuracy.

The invention also provides that the additive substance is more finely cut than the tobacco. This degree of fine cutting makes it easier for the additive substance to be evenly distributed in the suction stream and in the tobacco rod. Vibrations also occur during transport of the cigarettes to the points of sale, which additionally distribute the additive substance uniformly in the tobacco rod.

In another embodiment of the invention, fine-cut components of the hemp plant are used as an additive substance. Although hemp contains resin and oil that gum up the parts of the cigarette machine that it contacts, hemp can be processed as an additive substance. According to the method, hemp is added to the suction stream to minimize sticking of machine parts. Other smokable additives are also conceivable, such as herbs or cloves, which give the cigarette smoke a certain aroma.

Expediently, the components of the hemp plant are chopped for fine cutting. This allows the degree of fine cutting to be precisely adjusted, in particular the degree of fine cutting of the hemp plant can be adjusted so that the hemp parts are well distributed in the suction stream and in the tobacco rod and combine homogeneously with the tobacco rod.

A further aspect of the invention relates to a cigarette machine for implementing the method described above, comprising a metering device with a feed line, which feed line opens out below the lower side of the first conveyor belt and with which metering device a smokable additive substance can be metered into the suction stream mixed with separated tobacco. Positioning the feed line so that the additional substance can be added to the suction stream ensures that a sufficient quantity of additional substance can be added even at high production speeds and correspondingly large numbers of cigarettes can be made. Positioning the feed line so that the additive enters the suction stream also ensures that as few parts of the cigarette machine as possible come into contact with the additive. This reliably prevents contamination of machine parts with the additive.

In another embodiment of the invention, the feed line is arranged substantially in the middle of the length of the suction beam. This allows the additional substance to be surprisingly evenly distributed in the tobacco rod formed at the bottom of the first conveyor belt.

It is advantageous if the metering unit is a vibratory feeder. The vibratory feeder is robust and requires little maintenance. In addition, the feed rate of the additive can be precisely metered.

In another embodiment of the invention, the oscillating conveyor comprises a spiral conveyor with a spiral-shaped spiral pot, which spiral pot is set in oscillation, whereby the additional substance can be conveyed in the direction of the suction flow. The spiral conveyor, which is usually used for the separation and positioning of individual parts, makes it possible in a surprising way to feed a sufficiently large and precisely dosed quantity of additional substance into the suction stream.

Expediently, the vibratory feeder comprises a vibratory hopper with which the spiral pot can be filled as a function of the filling level of the additional substance in the spiral pot. As a result, the spiral pot is always automatically optimally filled in order to be able to convey the additional substance into the suction stream in sufficient and precise quantities.

Expediently, the vibratory feeder comprises a laser with which the level in the spiral pot can be measured. The laser continuously measures its distance from the additional substance present at one point in the spiral pot. As soon as the additional substance falls below a first predefined distance, the vibrating hopper is automatically started up and continues to feed additional substance until a second predefined distance between the additional substance and the laser is reached, which is smaller than the first predefined distance.

### BRIEF DESCRIPTION OF THE DRAWING

Further advantages and features result from the following description of an embodiment example of the invention with reference to the schematic illustrations. It n non-scale representation:

FIG. 1: shows a principle sketch of a cigarette machine to explain the method for producing cigarettes.

### DETAILED DESCRIPTION OF THE INVENTION

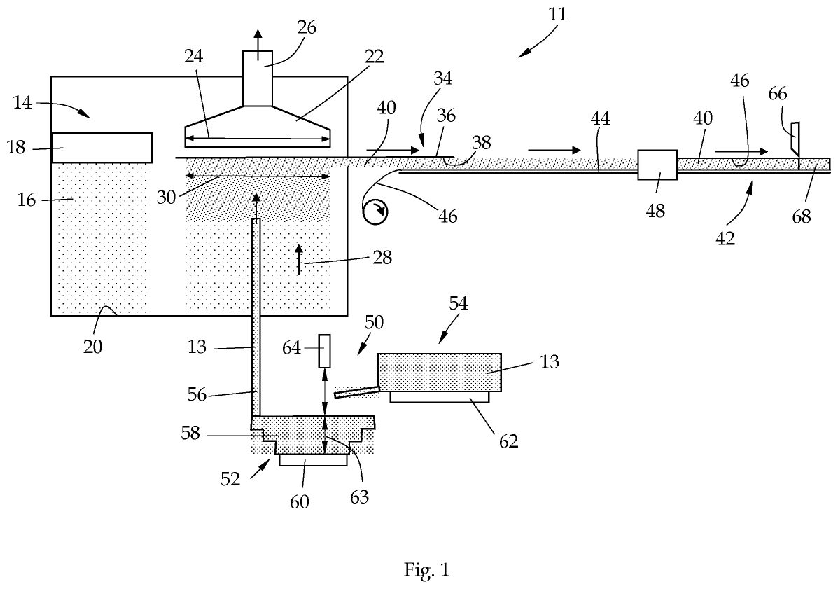

FIG. 1 shows a cigarette machine, which is designated in its entirety by the reference numeral 11. The cigarette machine may also be referred to as a cigarette rod machine. The method makes it possible to produce cigarettes in a simple manner, which contain a smokable additive substance 13 in addition to tobacco. Also, the new method makes it possible to increase the manufactured number of cigarettes with additional substance 13 per minute by a factor of 10 compared to prior art methods.

The cigarette machine 11 includes a tobacco sifter 14, which separates cut tobacco 16 and is also referred to as a “hopper”. The cut tobacco 16 is guided over a rotating roller 18 or “spreader” for its separation. The roller 18 pulls the cut tobacco 16 evenly apart and the tobacco falls from the bottom of the roller 18 onto the bottom 20 of the tobacco sifter 14.

A suction bar 22 having a length 24 is arranged in the tobacco sifter 14. The suction beam 22 is connected to an air suction unit 26. This creates a suction flow 28 which pulls or sucks the separated tobacco 16 against the force of gravity in the direction of the suction

beam 24. The suction stream 28 has a width 30 which is defined by the length 24 of the suction beam 22 along which air is sucked.

A first conveyor belt 34 having an upper side 36 and a lower side 38 is arranged below the suction beam 22. The first conveyor belt 34 is air-permeable, but largely prevents the passage of tobacco 16 toward the suction beam. The first conveyor belt 34 is a fabric belt which is permeable to air and impermeable to tobacco. The sucked tobacco 16 is retained at the bottom 38 and is formed into a tobacco rod 40 at the bottom 38 by compressing the tobacco rod 40 at the bottom 38 by the suction flow 28.

After the tobacco rod 40 is formed on the lower side 38 of the first conveyor belt, it is transferred to an upper side 44 of a second conveyor belt 42. Before the tobacco rod 40 is transferred to the second conveyor belt 42, a cigarette paper belt 46 is arranged or unrolled on the upper side 44 of the second conveyor belt 42, which moves along with the second conveyor belt 42 on the upper side 44. The tobacco rod 40 therefore comes to rest on the cigarette paper belt 46.

The tobacco rod 40 is guided through a mouthpiece 48. The mouthpiece 48 automatically wraps the tobacco rod 40 with the cigarette paper band 46 with a forming shoulder when the tobacco rod 40 and the cigarette paper band 46 are pulled or guided through the mouthpiece. At the same time, the cigarette paper band 46 is glued along its longitudinal sides.

The smokable additive substance 13 is metered into the suction flow 28 mixed with tobacco 16, and the tobacco rod 40 is formed from the tobacco 16 and the additive substance 13 at the lower side 38 of the first conveyor belt 34. The additive substance 13 comprises fine-cut plant parts of the hemp plant. For example, this may be the flowers of the hemp plant. The degree of fine cutting of the additional substance 13 is greater than the degree of fine cutting of the tobacco 16. Thus, the additional substance 13 is more finely cut than the tobacco 16.

The metering of the additional substance 13 into the suction stream 28 leads to some surprising advantages: The additional substance 13 distributes evenly in the formed tobacco rod 40 and no spots with concentrated additional substance 13 are formed in the tobacco rod 40. If the production speed or the conveyor belt speed is increased, the metering speed of the additional substance 13 does not form a limiting variable. The metering speed into the suction stream 28 can therefore be increased as required. Also, by metering the additive substance 13 into the suction flow 28, contact of the additive substance with machine parts is minimized or is not present at all. This is particularly important if the additional substance 13, such as hemp, contains resin, because the inventive method prevents machine parts from becoming resinous and having to be constantly greased or cleaned.

Contrary to the expectation that the additional substance 13, which is more finely cut than the tobacco, accumulates at the upper side 36 and is therefore inhomogeneously distributed, the additional substance 13 distributes evenly in the tobacco rod 40. In particular, if additional substance is metered to the suction stream 28 substantially in the middle of the width 30 of the suction stream 28, a particularly homogeneous distribution of the additional substance 13 in the tobacco rod 40 can be achieved.

The additional substance 13 is metered into the suction stream 28 by a vibratory feeder, which vibratory feeder is designated in its entirety by the reference numeral 50. The vibratory feeder 50 comprises a spiral feeder 52, a vibratory hopper 54 and a feed line in the form of a feed trough 56.

The spiral conveyor 52 is equipped with a spiral-shaped spiral pot 58, which is vibrated by a first oscillating drive 60. In the spiral pot 58, the additional substance 13 is conveyed in a spiral from the inside and bottom to the top and outside. Typically, the spiral conveyor 52 is used to align and separate individual parts so that they can be held fast by a gripper at the exit of the spiral pot 58. Surprisingly, it was found that the spiral conveyor 52 conveys the additional substance 13 as rapidly and uniformly as desired. As a result, the spiral conveyor 52 enables no bottleneck of added substance 13 to occur, even if the conveyor belt speed of the cigarette machine 11 is between 5 m/s and 7 m/s, for example. Furthermore, the dosing amount of the spiral conveyor 52 is very accurate. The vibrating spiral pot 58 has a fixed connection to the conveyor chute 56, whereby the conveyor chute 56 also vibrates and the additive substance 13 is transported to the open end of the conveyor chute 56 and is fed directly into the suction stream 28.

The vibratory hopper 54 is vibrated by a second vibratory drive 62. The additional substance 13 is stored in the vibrating hopper 54 and is conveyed to the center of the spiral pot 58. The delivery rate of the additional substance 13 can be adjusted to the delivery rate of the tobacco 16 or the delivery speed of the tobacco rod 40 by the first and second vibratory drives 60, 62. As a result, an amount ratio between the tobacco 16 and the additive substance 13 can be precisely adjusted. The oscillating drives 60, 62 may also be related to the delivery rate of the tobacco 16 so that the quantity ratios between the tobacco 16 and the additive substance 13 remain constant when the delivery rate of the tobacco in the cigarette machine 11 is changed.

The level 63 of the additional substance 13 in the spiral pot 58 can be measured with a distance meter 64, which may be a laser. Depending on the measured level 63, the vibrating hopper 54 is activated until the level 63 has reached a predefined value.

The tobacco rod 40 wrapped with the cigarette paper band 46 is cut into cigarettes 68 by a knife 66.

The method described has the advantage that a sufficient quantity of the additive 13 can be metered very accurately into the tobacco 16, even if the conveying speed of the tobacco rod 40 is high or the number of cigarettes 68 produced per minute corresponds to the quantities of cigarette machines which produce cigarettes without a metered additive 13.

Another advantage is that the method makes it possible to produce cigarettes to which an additive substance 13 has been added, while at the same time greatly reducing contamination of the cigarette machine 11 with the additive substance 13. As a result, additive substances containing resin, for example fine-cut constituents of the hemp plant, can also be used without the resin gumming up the cigarette machine 11.

1. A method of producing cigarettes in a cigarette machine, comprising:
separating cut tobacco in a tobacco sifter,
collecting the separated tobacco at a bottom of the tobacco sifter,
sucking the separated tobacco in a suction stream to a lower side of a first air-permeable conveyor belt by arranging a suction bar above an upper side of the first conveyor belt, which suction bar is connected to an air suction,
metering a smokable additional substance, which contains resins which would otherwise contaminate the cigarette machine, into the suction stream and mixing the smokable additional substance with the tobacco,
wherein a width of the suction flow is defined by a length of the suction, and wherein air with tobacco and the smokable additional substance is sucked in along the length of the suction beam,
forming the tobacco is formed into a tobacco rod at the lower side of the first conveyor belt by being compressed at the lower side of the first conveyor belt by suction stream, the tobacco rod comprising the tobacco and the smokable additional substance,
transferring the tobacco rod from the lower side of the first conveyor belt to an upper side of a second conveyor belt, on which upper side a cigarette paper band is arranged,
guiding the tobacco rod on the upper side of the second conveyor belt through a narrowed mouthpiece,
wrapping the tobacco rod with the cigarette paper band at the mouthpiece,
gluing the cigarette paper band along the longitudinal direction of the rod,
cutting the tobacco rod into cigarettes.

2. The method according to claim 1, further comprising metering the smokable additive substance into the suction stream essentially in a middle of the width of the suction stream.

3. The method according to claim 1, further comprising metering the smokable additive substance into the suction stream by an oscillating conveyor device.

4. The method according to claim 3, wherein the oscillating conveyor comprises a spiral conveyor with a spiral-shaped spiral pot, which spiral pot is set into oscillation, whereby the additional smokable substance is conveyed in a direction of the suction stream.

5. The method according to claim 4, further comprising filling the spiral conveyor by a vibrating hopper dependent on a level of the additional smokable substance in the spiral pot.

6. The method according to claim 3, wherein a delivery rate of the additional smokable substance metered in by the oscillating conveyor device is dependent on a delivery rate of the tobacco in the suction stream.

7. The method according to claim 1, wherein the additional smokable substance is more finely cut than the tobacco.

8. The method according to claim 1, wherein the additional smokable substance comprises finely cut constituents of a hemp plant.

9. The method according to claim 8, the constituents of the hemp plant are chopped for fine cutting.

10. A cigarette machine for producing cigarettes, comprising
a tobacco sifter in which cut tobacco is separated,
a suction beam connected to an air extraction and with which a suction flow with the separated tobacco can be sucked along a length of the suction beam,
a first air-permeable conveyor belt having an upper side and a lower side, the upper side facing the suction beam and the tobacco being formable into a tobacco rod on the lower side of the first conveyor belt.
a second conveyor belt, on the upper side of which a cigarette paper band can be arranged and on the upper side of which the tobacco rod can be transferred from the first conveyor belt, and
a mouthpiece at which the tobacco rod can be wrapped with cigarette paper tape,
a metering device with a feed line, which feed line opens out below the lower side of the first conveyor belt and with which metering device a smokable additional substance can be metered into the suction stream mixed with separated tobacco.

11. The cigarette machine according to claim 10, wherein the feed line is arranged substantially in a middle of a length of the suction bar.

12. The cigarette machine according to claim 1, wherein the metering device is a vibrating conveyor.

13. The cigarette machine according to claim 12, wherein the vibrating conveyor comprises a spiral conveyor having a spiral pot, which spiral pot is caused to oscillate, whereby the smokable additional substance is conveyable in a direction of the suction stream.

14. The cigarette machine according to claim 12, wherein the vibrating conveyor comprises a vibrating hopper with which the spiral hopper can be filled as a function of a filling level of the smokable additional substance in the spiral hopper.

15. The cigarette machine according to claim 13, wherein the vibrating conveyor comprises a laser with which a level in the spiral pot can be measured.
